(19) United States
(12) Patent Application Publication
(10) Pub. No.: US 2004/0025671 A1
(43) Pub. Date: Feb. 12, 2004

(54) Automated music arranger

(76) Inventor: Allan John Mack, Williamstown (AU)

Correspondence Address: A J Mack, Rosewood, PO Box 55, Williamstown, 5351, AU

(21) Appl. No.: 10/416,143

(22) PCT Filed: Nov. 13, 2001
(86) PCT No.: PCT/AU01/01464

(30) Foreign Application Priority Data
Nov. 17, 2000 (AU) PR 1507

(51) Int. Cl. G10H 1/38; G10H 7/00

(52) U.S. Cl. 84/613

(57) ABSTRACT

Field Music editing and harmonizing.

Problem

Good practice in the writing of harmony has been encapsulated in an extensive set of formal rules. It is a difficult and tedious mental task to check music for compliance. However, music so harmonized almost always sounds pleasing.

Solution

In the best Implementation, an editor and a Harmonizer are integrated, sharing the rules of harmony. The Harmonizer harmonizes a melody in accordance with the rules using an iterative technique of advance and retreat by trial and error. At difficulties, the Harmonizer compromises preferences, to produce an optimum solution.

The editor facilitates:

preparation and refinement of the melody;

submission of the melody to the Harmonizer;

the presentation of the harmony;

the analysis of other music by the rules.

Uses

the automated creation of a harmony complying with the rules;

the automated analysis of existing or manually composed music.

### DESCRIPTION

1. Technical Field

The field of the invention is music. More specifically, the field is automated creation of harmony for melody and editing of music. The best implementation is in software form.

Definitions

The terms “harmony rules” and “rules of harmony” each refer to the body of knowledge accumulated over recent centuries by specialists and others in the field of music which knowledge is recognised as preferred practice in the use of harmony. The rules are exemplified in the book “Longmans' Music Course Part II—Harmony and Counterpoint”, by T. H. Bertenshaw, Longmans Green and Co., Ltd., London (1926).

The musical term “note” implies, inter alia, its pitch (some writers use the term “tone”).

Terms distinguished by an initial upper case are defined for the easier reading of this document:

“Implementation” refers to “the mode for carrying out the invention” (“Mode” used in the musical sense (major/minor) will be apparent by its context.)

“Melody” refers to a complete melody or a contiguous portion of a melody or a single note.

“Harmonizer” refers to means in the current invention for creating an accompaniment.

“Editor” refers to music editor means in the current invention with which, in the best Implementation, the Harmonizer is integrated.

“Rules” refers to the set of harmony rules encoded into the current invention or accessible by it. The Harmonizer does not violate the Rules.

See “Representative List of Harmony Rules” appended to the description.

“Controls” refers to parameters determined by the user of the Harmonizer, which direct the Harmonizer process. The Harmonizer does not violate Controls.

“Preferences” refers to parameters not being Controls some of which are determined by the user of the Harmonizer and others of which are initialised by the Harmonizer. Preferences also direct the Harmonizer process. The Harmonizer can weaken (compromise) the requirements of Preferences when it exhausts its options.

2. Background Art

Traditional Methods

Music has long been harmonized manually. That is, whether composers enter the notes or chords into a machine, such as a computer, or write them by hand, they rely on their knowledge of the rules of harmony, or on what they think sounds good to their own ear. It is a tedious process, it is possible to miss the best solution, and it is difficult to comprehend simultaneously all the many rules. It is easy to find errors in compositions of even the great composers, including Bach; and Mendelssohn is noted (Bertenshaw, cited) for breaking the rules.

It is recognised that breaking the rules is sometimes deliberate in order to achieve a particular effect, and the b st Implementation does not preclude this being done manually after harmonizing.

Traditional methods of harmonizing include manual iterative procedures in which, upon the seemingly satisfactory creation of a chord, the composer advances to create the next. The composer will often have a pre-conception of what chord should be used, but may find that, after attempting various permutations of the chord parts, the Rules cannot be accommodated. If this remains the case after trying several of the better choices of chords, the composer, rather than trying a poorer choice, will retreat to the previous chord to try alternatives there similarly. If several such iterations are necessary, the composer may try something more radical at an earlier chord in the hope of finding a solution more readily. The Harmonizer formalises each of these processes, with the qualification, however, that even at the point of trying “something more radical” it will not break the Rules. None of the following inventions discloses this kind of iteration.

Comparison with U.S. Pat. No. 5,525,749

The invention of U.S. Pat. No. 5,525,749 is described as a composition/arrangement assistant, in which a set of notes (referred to as tones) based on the melody note and the melody tonality (scale and mode) is presented to the user who then selects notes from that set for the other voices of the arrangement. Compliance with the rules of harmony, except for a few mentioned below, is left to the judgement of the user.

The Harmonizer differs in that formal chords, characterised by degree, mode, species and inversion, are developed successively from sets of chord specifications which, in the design of the Harmonizer, were assigned to each possible melody note. The Harmonizer assigns notes to each voice without user involvement, assesses the chord, and reallocates the parts or chooses another chord if the former chord is unsatisfactory. The harmonizing of the Melody proceeds to completion without user interaction.

The invention of U.S. Pat. No. 5,525,749 prohibits consecutive (parallel) fifths and octaves and prohibits minor ninths from the melody. This can be done without a knowledge of the species of chords, and represents a very small portion of the rules of harmony developed over the recent centuries. The Harmonizer is distinguished by its ability to identify chords by degree, mode, species and inversion, and by its ability to identify the distribution of their parts amongst the voices. This information is essential as the Harmonizer then proceeds to assess chords for their compliance with the many rules of harmony available to it.

The Harmonizer is therefore distinguished in that it proceeds without user intervention and that it produces an accompaniment in accordance with the Rules.

Comparison with U.S. Pat. No. 5,496,962

The invention of U.S. Pat. No. 5,496,962 creates a plurality of options, analyzes those options exhaustively, attributes weighting factors to those options, and chooses the “best”. The Harmonizer's options are predetermined and ordered in its design. The Harmonizer assesses chords taken in turn until one meets certain criteria. The criteria derive from the Controls, from the Preferences, from parameters describing the Harmonizer's assessment of the quality of its harmony, and from compliance with the Rules. The Harmonizer accepts the first chord meeting the criteria, and looks further only if it later retreats to said Melody note.

The objective of the invention of U.S. Pat. No. 5,496,962 is to compose original music, employing randomness amongst other processes, whereas the objective of the Harmonizer is to create parts for voices to accompany an existing Melody, without randomness. With the same user settings, the Harmonizer exhibits repeatability.

This comparison shows differences in method, objective and outcome.

There is no disdosure of the extent of the rules of harmony employed by the invention of U.S. Pat. No. 5,496,962, and therefore no assurance that the set of rules is comprehensive. Nevertheless, this invention possibly comes a little closer to the Harmonizer in its use of the rules of harmony than does any other discussed here.

Comparison with U.S. Pat. No. 5,451,709

The invention of U.S. Pat. No. 5,451,709 is an automatic composer using a (dynamic) database of chord progressions and employing pattern matching in the creation of a melody. The invention does not refer to the rules of harmony, upon which the Harmonizer relies heavily. The Harmonizer has a few prohibited chord progressions, the better known being Ia to Ia and IIa to Ia. Otherwise, the Harmonizer achieves good chord progression as a secondary consequence of enforcing the many other rules of harmony.

The selection of chord progressions by pattern matching samples is a process entirely different from that of the Harmonizer.

Comparison with U.S. Pat. No. 4,982,643

The comments on U.S. Pat. No. 5,451,709 apply here also. References to “rules” in the disclosure of this and the previous invention refer to the rules of a knowledge base (expert system) and not to harmony rules.

Comparison with U.S. Pat. No. 4,926,737

The invention of U.S. Pat. No. 4,926,737 is an automatic composer using a melody motif. It relies on a (dynamic) database of chord progressions. The earlier comments under U.S. Pat. No. 5,451,709 on rules and chord progression apply here. The invention of U.S. Pat. No. 4,926,737, as a composer, is naturally concerned with the development of a pleasing melody, and much is made of the detection of “non-harmonic tones”. By contrast, the Harmonizer accepts a Melody from the user, and the quality and style of the harmony produced is somewhat dependent on the quality and style of the Melody.

Music editors

There is a wide range of music editors available, some known as “sequencers”. None is known having the Editor's capability of analysing music according to the rules of harmony. A few are capable of displaying a limited number of chord types. By contrast the Editor displays a comprehensive range of chord species with their degree, inversion, mode, intervals, semitones, figured bass, current scale key and current scale mode. No other music editor is known having the Editor's capability of identifying chords of ambiguous identity according to their musical context.

Summarising th Comparisons

The Harmonizer appears to be unique in distinguishing harmony rules that must be complied with, from other rules and preferences that may be compromised. Its use of a comprehensive set of harmony rules as the major component in the process of harmonizing appears to be unique.

The Harmonizer appears to be unique in its iteration technique when applied to automated music harmonizing.

The Harmonizer appears to be unique in its repeatability for given Melody, Controls and Preferences. There is no random process in the Harmonizer.

The Editor appears to be unique in its capability of analysing music according to the rules of harmony.

The Editor appears to be unique in its capability of identifying chords of ambiguous identity according to their musical context.

### DISCLOSURE OF INVENTION

The invention comprises:

means for editing music wherein is means for analysing music according to the rules of harmony; and

means for harmonizing a given Melody by an automated iterative process of successive chord selection in accordance with the rules of harmony.

In the best Implementation of the invention, the Harmonizer is integrated with the Editor so that each uses the same means of Rules analysis.

The user prepares an error-free Melody and submits it to the Harmonizer. The user sets Controls and some Preferences, to affect the character of the harmony. Other Preferences are initiated by the Harmonizer. The choice and allocation of accompanying notes is made solely by the Harmonizer.

Starting at the first Melody note requiring a chord, the Harmonizer selects a chord specification in order from a set of preferred chord specifications according to the scale mode and the Melody note's position (its degree) in the current scale key. A chord is created in accordance with said chord specification, with parts doubled as necessary to fill the voices. The chord is required to meet a plurality of criteria, some examples being the extent of leaping permitted, the range and separation of each voice, the overlapping and crossing of voices, variation from the harmony of preceding chords, and the requirements of cadences. Some of the criteria are progressively compromised in order when the Harmonizer encounters difficulties in selecting a suitable chord. Compromised criteria therefore implement Preferences. Other criteria are Controls, not negotiable.

The Harmonizer proceeds by placing successive chords so created into the music and submitting the music to the Rules, until a compliant chord is obtained, in which case the Harmonizer advances to the next Melody note. Alternatively, when there are no more chord specifications available, the Harmonizer retreats to the previous Melody note to continue in like manner there, the chord there now having failed.

The Harmonizer process is therefore characterised by advances and retreats along the Melody in user-nominated steps, with regions of compromised Preferences occurring if and where the Harmonizer has difficulty in complying with the Preferences, Controls and Rules. Harmonizing completes at successful creation of the last required chord.

Some features of the Editor, namely, the playing of the music, the publishing of the score and the burning of audio CDs each lie outside the scope of this invention but are mentioned to place the Harmonizer in the context of the user proceeding from the concept of a Melody through the Harmonizer process to the performing or playing of the completed music.

The number of voices created, which optionally includes descents, is unlimited in principle. One Implementation of the Harmonizer permits the creation of a) three additional voices below the Melody with b) an optional fourth voice being the descant, and c) four additional voices below the Melody.

The Editor has available to it the Rules so that any music held in the Editor is tested for Rules compliance. The Editor also uses the chord identification process that precedes the Rules testing, so that the characteristics of any selected chord are displayed.

Summarising the Advantages

The Harmonizer in conjunction with the Editor allows a user to move quickly from a Melody to a complete composition that complies with the Rules. Using a computer system with an appropriate sound system, the user may assess the composition aurally with selected instrumentation. The user may then refine the Melody, Preferences and Controls, for re-submission to the Harmonizer. The deterministic nature of the Harmonizer allows the user to make meaningful comparisons of alternative settings and to return to an earlier harmony confident of repeatability.

### THE BEST MODE FOR CARRYING OUT THE INVENTION

Some explicit references are made to modes other than the best Implementation.

### The Harmonizer

In the best Implementation, the invention is in the form of software operating in a personal computer system (PC) comprising central processing unit, random access memory, hard disk, monitor, keyboard, mouse, and optionally printer, sound card with audio system, and CD burner. The user interacts with the Harmonizer and the Editor by means of the monitor, the mouse and the keyboard. Some mouse operations have corresponding keyboard keystrokes.

Data Structure:

In the best Implementation, the notes, chords, marks, expression and other features of music are stored in data arrays according to their voice and to their order of playing (progression). The access to particular notes and chords is therefore by array subscripts. The arrays also represent the music layout, and so some array columns can be empty. The arrays also contain speed changes, rhythm changes and key changes as defined by the user.

In the best Implementation, the Harmonizer is invoked by a user command of the Editor, the user having established the Melody held in the Editor. The Harmonizer displays a panel in which the user can set Preferences and Controls at the user's option.

In the best Implementation, the Preferences comprise:

the preferred degree of leaping permitted;

the preferred variation of harmony at Melody pitch repetition;

the preference for compliance with modulation detected at cadences;

the preferred degree of close harmony;

the preference to avoid unison of adjacent voices; and

the preference to vary the bass voice pitch at bars (measures).

In the best Implementation, the Controls comprise:

setting the chord frequency ranging from one-per-Melody-note, through intermediate frequencies some including syncopation, to one-per-bar;

setting the variation of tied cadences where otherwise at cadences tied repeated Melody notes are treated as the second note of a cadence pair;

setting the voice range limits of accompanying voices;

setting the extension of the tenor-to-bass maximum interval by two beyond the one octave which is otherwise and elsewhere enforced between adjacent voices;

nominating the soprano voice or the descant (solo) voice as the Melody voice;

for the soprano voice as the Melody voice, nominating an optional descant as a “vocal” and “instrument” voice, the instrument voice having greater freedom of interval from the Melody;

the option of “true descant” meaning a descant which can be omitted from a composition without losing essential harmony; and

the copying of ties and the copying of staccatos from the Melody to other voices.

The user then commands the Harmonizer to commence. The Harmonizer first scans the Melody to establish iteration links according to said chord frequency, to establish the position of middle and final cadences, and to diagnose inappropriate Melody chromatics according to the scale mode. In the description that follows, the Melody notes at which chords are required according to said chord frequency are termed “nominated melody notes”.

Said iteration links for nominated melody notes are array subscripts.

In the best Implementation, the Harmonizer does not enforce the chord progression requirements of either the Rules or other user requirements, over section marks or Melody rests. These points are termed “melody breaks”. Retreats over melody breaks are therefore never advantageous and so the Harmonizer is prohibited from doing so.

Final Cadences are created before section marks, the Melody note there permitting.

The Harmonizer starts at the first nominated melody note.

First, the Harmonizer process is described in more general terms, that is, with several nominated melody notes preceding and following the point of discussion. Then end points are discussed.

General process:

In accordance with the scale mode and the degree of the nominated melody note the Harmonizer selects a chord specification from a set in which are chord specifications in order of preference for each of the melody notes of a plurality of scale modes. In the best Implementation each chord specification has a particular inversion, and the said set additionally includes chords for chromatic melody notes. In the best Implementation the said set is stored as a data array. In another Implementation the said set is defined by stored procedures.

The Harmonizer rejects some unsuitable chords specifications, based on their degree, species or inversion. One example of said rejections is a Rule, namely, that common chords of degree one and two may not follow the other. As another example, a user Preference may be that chords vary their degree upon Melody note repetitions. As yet another example, not all the chords in the table are necessarily acceptable at cadences. All such rejections are deemed chord failures—see # below.

If there are insufficient parts in the chord for the number of voices being created, the Harmonizer doubles some parts. The preferred parts to double in most species are defined in the rules of harmony and so this is one example of a Preference not controlled by the user. The Harmonizer allocates parts to the voices, and tests the voices for excessive range, excessive leaping, overlap, excessive separation and user Preferences including but not limited to close harmony, varying parts upon Melody note repetitions, and avoiding unison. Because chords selected from said set have a particular inversion, if the user Preference for Bass Motion fails, then the chord is deemed to fail—again see # below. In the case of other failures of said tests, the chord is deemed not to have complied with the Rules, otherwise the Harmonizer places the chord into the music, and submits the music to the Rules. # In the case of a chord failure, the Harmonizer selects by iteration the next chord specification from said set. If all available chord specifications fail, the Harmonizer retreats to the previous nominated melody note, deems the chord there to have failed the Rules, and iterates accordingly. # In the case of a chord failure, the Harmonizer selects by iteration the next chord specification from said set. If all available chord specifications fail, the Harmonizer retreats to the previous nominated melody note, deems the chord there to have failed the Rules, and iterates accordingly.

At compliance with the Rules, the Harmonizer advances to the next nominated melody note.

In the case of Rule non-compliance, the Harmonizer iterates with a new permutation of the parts other than the bass, except in those cases of the Rules where permutations cannot remedy a failure. Consistent with the requirements of overlap, crossing, unison and spread, it is sometimes possible to move a part by an octave to form a new permutation. Further permutations comprise: all permutations of preferred alternative parts to be doubled according to the number of additional parts needed; and the omission of fifths in certain chord species.

If all permutations fail the Rules, a chord failure is deemed.

End points:

In the case of a pending retreat at the beginning of the Melody or at a chord following a melody break, the Harmonizer completes processing having failed to find a solution.

If the chord at the last nominated melody note complies with the Rules, the Harmonizer completes processing having succeeded.

Parameter thresholds:

The iterations so far described do not account for the use of thresholds whose levels are varied and which limit the effect of some Preferences and other parameters. This technique has similarities to “Fuzzy logic” in knowledge-based (expert) systems, but is nevertheless deterministic. The purpose of thresholds is to compromise Preferences by degree rather than directly to their weak condition. The best Implementation employs such thresholds and they are described now:

A threshold is associated with the selection of chords from the set of chord specifications. Its weak level corresponds to the number of chords in the set for the nominated melody note. Its stronger levels limit the number of chords available.

Similarly, thresholds exist for the allowable leaping of voices and for the preferred parts that may be doubled.

The thresholds have a hierarchy, the threshold for the chords having the most freedom and that for the doubling having the least. Those thresholds below the chord threshold in hierarchy may not relax their levels beyond that of the threshold immediately above in hierarchy. No threshold level may be relaxed beyond that of the same threshold kind at the preceding chord. If there is no such preceding chord, such as at the first nominated melody note or at that following a melody break, the threshold may be relaxed one level, the threshold level above it permitting.

At failures of an iteration corresponding to a threshold, and if, as described above, the threshold level may be relaxed, then the Harmonizer does so by one level, and repeats the entire procedure within said iteration. Upon entry to any such iteration, including the case of advancing to the next nominated melody note, subordinate threshold levels are set to their strong value.

The effect of the thresholds is to implement the principle that, after trying several of the better choices corresponding to a given threshold, the Harmonizer, rather than trying a poorer choice, will retreat to the previous parameter or chord to try the next choice there, where it likewise iterates retreats and advances.

Excessive retreats:

Where the Harmonizer encounters difficulty in finding a solution, it may have to retreat by several nominated melody notes, unable in each case, as described above, to relax threshold levels because of the threshold levels of the previous nominated melody note. That is, no relaxation can occur until the Harmonizer reaches the first nominated melody note, or that following a melody break. If the Harmonizer has to retreat more than a few chords, the number of permutations that can be tried compounds so quickly that execution times become unacceptable. To break this sequence, and in so doing to imitate human practice, after a few consecutive retreats, the Harmonizer may disregard the previous chord in assessing whether it may relax threshold levels.

The number of thresholds:

The best Implementation employs the three thresholds described above. Derivatives of the threshold levels control other iterations, two examples being the avoidance of unison, and the omission of fifths. Other Implementations of the Harmonizer employ different combinations of thresholds and their derivatives to similar effect, within the scope of the Claims.

Without thresholds:

In another Implementation, there are no thresholds, and the Preferences that would have had thresholds are subjected to the same kind of hierarchical and excessive retreat processes. The harmonies so created would of course still comply with the Rules, but the selection of chords may to some extent be less optimum and the harmony sound less flowing.

Example of Harmonizer main loop:

In the best Implementation, the main loop is illustrated by the following pseudo-code:

do

if advancing then reset chord specification threshhold

do

if advancing then reset progression threshhold

do

if advancing then reset doubling threshhold

do

if advanced then reset chord pointer

do

configure a chord and evaluate (includes submission to Rules)

if the chord complies then exit to end of outer loop, to “advance”

loop if another chord is available

loop while the doubling threshhold can be relaxed

loop while the progression threshhold can be relaxed

loop while the specification threshhold can be relaxed

set “retreaat”

loop while able to advance or retreat

Varying Harmony:

When variation is set, the Harmonizer prefers a change in the allocation of the parts or a change in the chord degree, at melody notes of repeating pitch.

Close Harmony:

Close Harmony prefers that the interval between a Melody note and that of the next note below it may: a) not exceed 3, b) additionally be 6, and c) further additionally be 8, at the user's option.

Leaping:

Leaping is assessed by 1) changes in pitch of each part, and 2) total change of pitch in all parts.

Establishing cadences:

Middle cadences are established principally by the recognition of longer Melody note durations. The latter of any two potential cadences close together is chosen over the former. Middle cadences also are established at pause marks. Final cadences are established at the end of the Melody, and also before section marks where the Melody permits—that is, at tonic, mediant or dominant Melody notes.

In the best Implementation, each cadence chord and its preceding chord are restricted procedurally to chord progressions deemed appropriate for each possible melody progression. In another Implementation, tables of said chord progressions restrict chord selection.

A common cadence form comprises a held melody note with a change in the accompanying chords. The Harmonizer can achieve this at tied repeated Melody notes, the user setting the Harmonizer Control “Vary tied cadences”. The Harmonizer treats said tied notes as one for the purpose of recognising the cadence by duration, but treats the notes sparately for the creation of chords. Otherwise, tied repeated Melody notes are treated as the one second note of a cadence.

Modulating cadences:

The Harmonizer automatically modulates middle cadences if Melody notes uniquely characteristic of an alternative key are present before and within a bar of the cadence.

Additionally, at the user's Preference, Melody notes similarly before the cadence are assessed as potential roots, thirds and fifths of the chord to be preferred at the cadence.

Other Modulation:

At each bar and also following middle cadences, the occurrence of a Melody note of longer duration within the bar affects the choice of the current chord in that the note at said occurrence is preferred to be a root, third or fifth of said current chord.

In the best Implementation, this modulation detection is automatic—not a user option.

Analysis by the Rules:

In the best Implementation, the Harmonizer identifies chords by the same process used by the Editor generally, without reference to the said chord specifications. This ensures that automated harmonies are assessed by the Rules exactly as is other music held in the Editor.

The analysis comprises the following:

means for determining intervals, semitones and doubling of voices;

means for determining the degree, mode, species and inversion of chords;

means for accounting for the presence and absence of preceding and following chords, and of passing notes, as the Rules require; and

means for evaluating compliance with the Rules.

In the best Implementation, notes are defined in part by pitch measured in semitones, and so the semitones between voices is self-evident. The determination of each note degree accounts for the scale key, scale mode and any chromatic (accidental) present to determine the scale degree (diatonic) with which the pitch of a note is associated, such that a “tonic” note is represented by 1, “supertonic” note by 2 and so on by unit steps to the “leading” note by 7. To more readily distinguish the minor seventh from the leading note, the minor seventh is given the value 14, chosen because of its equivalence to 7 whenever the operation “mod 7” is performed.

To overcome the ambiguity of chromatics, there is for each note a sharp and flat preference which derive from the scale and which can be overridden by the user's use of an accidental. Further, there are two special cases accounted for being 1) the leading note chromatic in the minor mode; and 2) F represented as E# in the scales of F# and D#m. In the best Implementation certain scales are not recognised, one example being C flat, B being preferred.

The interval between two notes is given by:

(the difference between the note degrees) mod 7+1.

The inversion and mode are derived from the said intervals and said semitones. In the best Implementation, the chords of the dominant thirteenth are derived by comparison with stored values of intervals and semitones for each inversion, whereas other chords are derived procedurally, each. technique deemed appropriate in their case, the procedural technique generally being faster.

Some chord configurations are ambiguous, and the ambiguity is resolved by reference to the following chord of each. That is, a chord may change its identity during a scan for Rules compliance, such that a chord may be approached as one form and left as the other. This is in accord with the Rules (§661-5). The Harmonizer chooses the alternative most likely to satisfy the rules of progression and resolution. The best Implementation distinguishes the following ambiguities:

sus4c and 7sus4a;

sus9&4a and 7sus4d;

9a and sus9&4b;

7th (without a 5th) and sus9; and

7th (with a 5th) and 9th.

In retreat, the Harmonizer removes a failed chord from the music lest it affect ambiguities.

The Harmonizer derives the root name (chord degree) from the inversion, the bass degree and the scale key, either directly if the root is present, otherwise by difference from another part. The Harmonizer finds the mode of a chord by reference to the semitones of the third, or, when the third is absent, by reference to the semitones of the third of the chord of resolution.

Performance:

In the best Implementation of the Harmonizer, the scan of music for Rules compliance during the process of harmonizing is limited to the few bars prior to the current Melody note, in the interests of better speed performance when harmonizing a long piece.

Implementing the Rules:

In the best Implementation, compliance with the Rules is determined procedurally, and as one example, the two rules §361 and §386 combined are illustrated by the following pseudo-code:

VI to V progression:

If the preceding and current chords are at their root positions then

if the preceding chord is of dominant root then

if the preceding chord is a tried in a minor key or a seventh in a major key then

if the current chord is a submediant triad then

if the preceding chord has no seventh and no fifth then rule &Ovalhollow;361 fails

if the third of the current chord has no double then rule §386 fails

end if

else if the current chord is a dominat triad then

if the previous chord is a submediant triad in a minor key then

if the current chord has no fifth then rule §361 fails

if the third of the previous chord has no double then rule §386 fails

end if

end if

end if

Monitoring the Harmonizer:

In the best Implementation, the Harmonizer displays advances and retreats along the nominated melody notes, showing all chords which satisfy the Rules. The Harmonizer regularly adjusts the display so that the area of interest is centred. At each nominated melody note the Harmonizer displays: a Melody note position number (its subscript); the chord parts by number against each voice; the nature of the beat (pulse); the degree of the Melody note by number according to the current scale; and the degree, species and inversion of the chord. The Harmonizer brightens the beat symbol at cadences, and brightens a part number if its octave option is taken. Any changes of key encountered during advance or retreat are accounted for in the selection of chord specifications and in the Rules, and the current key is displayed. The user has the option of quitting the Harmonizer process prematurely in which case control returns to the Editor. An implementation of the Harmonizer shows progress as a bar. Another numerically.

An implementation of the Harmonizer additionally incorporates an optional trace facility whereby the user may set a trigger point and may step through the Harmonizer process by single selected chord-specification steps or by advance and retreat steps. In the trace mode, performance is not an issue, and so the Harmonizer can afford to display more information: therefore, details of unsuccessful chords are also displayed, together with reasons for their failure. Commands allow normal (non-trace) mode to resume, the setting of another trigger point, or an immediate quit of the Harmonizer process in which case control returns to the Editor.

Quality assurance:

Each of the above monitoring facilities can provide the user with assurances of quality. Using the Editor to prepare test phrases to exercise the Rules assures the quality of the Rules and by implication the quality of the Harmonizer.

### The Editor

The best Implementation of the Harmonizer is integrated with a music editor so that:

the Rules analyze any music, whether created by the Harmonizer or not;

the Editor determines and displays the degree, mode, species, inversion, intervals (figured bass), semitones and current scale key and scale mode of user selected chords;

automated harmonies subsequently may be manually edited, breaking rules if so desired;

the distribution of voices amongst staffs may be altered, and the music prepared for publication;

voices may be assigned instruments, exported in MIDI form, and assessed aurally; and

the Melody may be readily edited and resubmitted to the Harmonizer.

In the best Implementation, some features essential to the operation of the Harmonizer are embodied in the (integrated) Editor. They comprise:

means for the user to set the rhythm and key, and changes to each thereof, of music held in the Editor;

means for the Editor to establish the position and nature (accents) of beats (pulses); and

means for the user to nominate the voice (descant/solo or soprano) as the Melody voice.

In the best Implementation, the Editor contains other facilities that enhance the usefulness of the Harmonizer. Some examples are:

means for the Editor to display in score form the music held in the Editor;

means for the user to alter the displayed distribution of voices amongst the staffs and to vary the number of staffs per system (brace of staffs);

means for the analysis, by the Rules, of the music held in the Editor;

means for the Editor to display breaches of the Rules, wherein the Editor identifiably colours notes and successively displays text describing the breaches at a user selected chord;

means for the user to freeze by key and to release by key and by mouse said succession;

means for the user to alter the musical characteristics of, and add and remove, notes and rests held in the Editor;

means for the user to add and remove expression marks, signs, ties, pauses, and section marks, each being effective in the creation of audio files;

means for the Editor to convey Melody tie, pause, and staccato information to the Harmonizer;

means for the user to insert, delete, cut, copy, and paste blocks of chords held in the Editor;

means for the user to exchange parts between the voices of music held in the Editor;

means for the user to set speed and speed changes within music held in the Editor;

means for the user to transpose up and down all of and part of music held in the Editor;

means for the Editor to represent chords by chord notation and by figured bass (interval);

means for the Editor to search music for chords by degree, mode, species, or inversion;

means to import, add, delete and edit lyrics;

means to save music to files and to load music from files;

means to select instruments and their levels, to nominate introductions and repetitions (each repetition with or without descant);

means to create corresponding audio (MIDI) files and audio output representing all of or part of music held in the Editor,

means to create said audio files and audio output wherein accents vary the level of sound;

means to create paginated graphical image files of music held in the Editor;

means for the Editor to merge repeated notes;

means for restricting said merging to tied notes;

means for saving and acquiring the settings of Preferences and Controls for a harmony;

means to adopt said settings for use by the Harmonizer, whether for the same or another Melody; and

means to save and retrieve a plurality of instrument and volume (level) presets.

Of the above disclosed features that are novel, those skilled in the art will appreciate the detail entailed in the implementation of most. Others are further elaborated as follows:

Scanning for beat:

Some rules require knowledge of the position of accents. All music held in the Editor has defined, by default or by the user, the rhythm and the number of beats in the first bar. The Editor determines the position of bars, accents and beats by accumulating, in each voice, note and rest durations, and by comparing the accumulations with said rhythm or with the rhythm as it changes in the course of the music. Where the Editor detects discrepancies between voices or notes overlapping a bar, the Editor indicates bar errors on the display by an identifiable colour.

Error Display succession:

Error Display succession minimises the use of the display area. The details of breaches of the Rules are stored in a circular data array (that is, a conventional array in which the subscripts are circular). After the text of a breach has been displayed for a short time, the Editor selects the next breach in the array and displays it in the same place. The Editor detects 1) the absence of any breaches so that other less significant messages can be displayed, and 2) the presence of only one breach so that there is no unnecessary display flicker.

Transposition:

Transposition includes appropriate changes of key and the maintenance of appropriate chromatics, by the use of the same data employed in said ambiguity of chromatics. Means for transposing the Melody can be particularly useful when the Harmonizer has difficulty due to the Melody being set too high or too low. The facility to swap voices allows any voice to be treated as if it were the Melody.

Searching for Chords:

The Editor makes use of its knowledge of chord characteristics in its facility to search music for occurrences of chords having characteristics defined by the user. The user may leave some search characteristics undefined, so that the search may be, for example, for all dominant thirteenths regardless of their inversion. The Editor searches from the current cursor position and places the cursor at the next chord matching the search criteria.

Merging Repeats:

At the user's option, a harmony is subjected to refinement whereby the Editor merges repeated notes in user-nominated voices into single notes of equivalent time by combination. Merges are limited such that the times of combination do not exceed a user-specified time. At the user's option, merges are limited to bed notes. Merging accounts for music theory rules concerning accents, and also requires that the times of the combinations can be represented by musical notation, so that not all repeated notes are necessarily merged. Merging tied repeated notes is useful in the Melody voice after “Vary tied cadences” described above. Note that where several voices of a chord become merged, there may remain only passing notes, and harmony errors may be so introduced. Merging is therefore done after the completion of a harmony.

### Other Implementations

Those skilled in the art will appreciate that other Implementations are possible within the scope of the Claims. So the invention may be practiced other than as described above.

In Implementations of the Harmonizer not integrated with the Editor, said Essential Editor features are incorporated in the Harmonizer, and, using prior art, alternative provision is made for the input of the Melody to the Harmonizer and the output of the harmony from the Harmonizer.

### Industrial Applicability

The Editor and the Harmonizer will each be of use to students and teachers of music theory and to any composer wishing to compose or Harmonize in accordance with the rules of harmony.

The analysis of music held in the Editor will serve as an aid to the learning, understanding and appreciation of the rules of harmony.

The invention will also be useful for re-harmonizing existing music for performance by particular groupings of instruments and/or singers, and the facility of the Editor to present music in chord notation or figured bass notation will be useful to those accustomed to those forms.

The best Implementation is in software form suitable for running on the majority of “PC” personal computers. The harmonizing of long pieces is better done on computers employing a CPU of “Pentium III” equivalent performance or better, for reason of speed only. The need for some of the Rules analysis to look ahead renders the Harmonizer unsuitable for real-time use.

### Notes Concerning the Claims

The claims reference the definitions under “TECHNICAL FIELD”, page 1.

In addition, “preceding Melody n te” means melody note at which a chord was most recently created preceding the current melody note.

### Representative List of Harmony Rules

The paragraph numbers are those of Reference 1, beginning at §250, there being an earlier volume, not of harmony rules. Only strict (“must”) rules are shown, unless otherwise stated. The missing paragraphs cover definitions, explanations, and preferred practice implemented as the Preferences.

Some rules continue the topic of preceding paragraphs—each rule should be read in its context.

There are certain apparent ambiguities and contradictions and the best Implementation reconciles them, one example being rule §328.

Harmony rules:

275 Three or more notes sounded_together constitute a chord.

292 Voices must not cross nor overlap.

328 If the bass of a major first inversion is doubled, the two voices must move to and from the chord by step in contrary or oblique motion.

Interpretation: understood not to apply when the chord repeats, nor to augmented fifths.

332 Where the bass of consecutive four-voice first inversions moves by step, no one chord part shall be doubled in both chords.

337 The second inversions of only the tonic, dominant and the subdominant common chords are permitted. (But see §603, §608, §636, §647)

342 The bass must not leap to a second inversion from a first inversion of a different root.

344 The bass of a second inversion must not leap, except from arpeggio to the first inversion of the same chord.

345 A second inversion, followed by a chord on the same bass note but not preceded by a chord on the same bass note, must occur on the accent of the bar.

346(a) The only consecutive second inversions permitted are of the dominant root followed by the subdominant root. (b) No voice may move in consecutive fourths with the bass.

353 In a minor key, the major sixth may not be used as part of a chord, except in the major (chromatic) chord of the supertonic (see §596) and its derivative (see §603).

Concession: This rule can force very unsatisfactory harmony when the major sixth occurs in the melody. Reference 3, Chapter 9 regards any note of the melodic minor as legitimate in a chord. The best Implementation implements §353 for other than the Melody voice. In practice, other rules, particularly §445, result in the Harmonizer producing appropriate modulation near the sixth.

361 When a chord of the dominant moves to a chord of the submediant, or vice versa, in a minor key, the dominant must be complete, and the third must be doubled in the submediant.

369 The minor seventh may be used in a chord as the bass of a first inversion only in a minor key where it is preceded by the tonic and followed by the minor sixth.

375, 486, 7 The seventh of a dominant seventh resolves by falling a second, rising a semitone, or remaining. The third resolves by rising a second, falling a semitone, or remaining.

379 No note may proceed by similar motion to the note (or 8ve) on which a dissonant note resolves.

377 No dissonant note may be doubled.

380 Subject to §375 etc above, the dominant seventh may resolve to any chord.

381 In resolving to the tonic, the seventh falls a second, and the third rises a second.

384 In resolving to the submediant, the seventh falls a second, and the third rises a second.

386 A submediant triad following a dominant seventh in a major key must double its third.

387(a) Before resolving, a seventh may first proceed to the root or the fifth of the chord—ornamental resolution, or, (b) before resolving, the seventh may transfer to another voice.

400 The dominant seventh may rise only from a second inversion to a tonic triad first inversion.

405 In addition to or in combination with §387(b), different inversions may follow, subject to §400.

414 Secondary sevenths must be prepared.

415 Preparation refers to the sounding of a note in the same voice before the chord in question. The preparation must be consonant.

416-23 In a secondary seventh chord, the seventh resolves by falling a second. The root rises a fourth to the root of the resolution. Note, however, that some sevenths are identical to inverted ninths, and may therefore have their resolutions (§578). Note also §517.

420 The second inversion of secondary sevenths is not used.

428 No voice may move a major seventh nor more than an octave.

429-30 A voice should not move by an augmented interval, except (a) resolving a note to a harmony note, (b) in a sequence (not formally implemented in the best Implementation), and (c) as passing notes in the harmonic minor.

Concession: the Melody is exempted for the sake of (b).

431 A voice moving by a diminished interval should return to a note within that interval.

433 The leading note must not be doubled. (a) The leading note in a perfect cadence must rise to the tonic; otherwise, (b) when the leading note is followed by a tonic chord, it must rise, but not necessarily to the tonic. (§298c not shown says better, which is implemented)

434 No two voices may move in perfect fifths.

436 The extreme voices may not move in fifths (perfect or diminished).

437-9 No two voices may move in octaves or unisons, unless a unison or octave passage is intended.

440-1 Hidden consecutive perfect fifths and perfect octaves of the extreme voices are prohibited except where a tonic chord moves to a dominant or subdominant or vice versa, the upper voice moving by step, or a chord moves from its first inversion to the root. Also see §500e, §535 & §536.

Concession: except the third of the first chord falling to the fifth of the second; or the upper voice moving by step—Ref. 2, p36.

443 No two voices may move in consecutive seconds or sevenths.

445 False Relation: a note in one chord having appeared in the previous chord or previous but one chord chromatically altered (or vice versa) must be in the same voice, except as in §446, 7, 9.

446 The earlier note (§445) may be doubled (but note rule §437).

447 False relation does not occur if the third of the first chord is the root or fifth of the second, nor when the altered note forms part of a fundamental discord.

449 Passing notes and their allies do not produce false relation.

485-7 (includes §375, §381-4, 7, §400) In a dominant seventh chord, the seventh may only fall a second, rise a chromatic semitone, remain to be a note of the next chord, transfer to another voice, or, where the second inversion is followed by a tonic first inversion, rise a second. The third may only rise a second, fall a chromatic semitone, or remain.

492c A suspension must resolve by proceeding by step (§493) to a harmony note on the chord over which it is suspended (but see §506).

495The suspended ninth resolves by falling to the eighth.

500a A suspension must be prepared (§415).

500b A suspension must occur on an accent.

500e No suspension is allowed if in its absence forbidden consecutives would occur.

500g A second cannot resolve on a unison (covered by §554).

506 Some interchange of parts is allowed in the resolution of a suspension, but if a voice moves to the note of resolution, it must be by contrary motion.

507 The suspended fourth resolves by falling to the third.

510 In the first inversion of a suspended fourth, the fourth is a ninth above the bass (see §554, reading fourth for ninth and third for root)

517 The leading note can be a suspended seventh of the tonic, resolving to the eighth. (cf. §416)

519, 520 Suspensions may resolve ornamentally, moving to other harmony notes of the same chord, or as passing or auxiliary notes, provided the correct resolution occurs before the chord changes.

535 Passing notes in several voices at once must move by contrary motion unless they make satisfactory combinations.

Interpretation: satisfactory combinations: Ref 2, p80 states that they usually move in thirds or sixths. The best Implementation requires that, unless they are moving contrary, the two notes should maintain their interval, and lets the rules for consecutives catch the illegal ones. Three passing notes are deemed to form a new chord, with all that that entails (§275).

536 Rules §434 to §443 (that is, chord to chord) apply also in the presence of passing notes.

537 Passing notes must not introduce the prohibited consecutives.

548 The dominant ninth may be major or minor.

550 The major ninth may not be used in a minor key—see §353.

552 Unless it descends at once to the root, the major ninth must be above the third.

553 The dominant ninth resolves by rising or falling a second. The rest of the chord may remain (dominant seventh), or (see §555).

554 A resolution must not be sounded with the dissonant note, except that, where a ninth resolves onto the root, the root may be sounded in the bass.

555 The dominant ninth may resolve to a tonic common chord, the ninth falling a second.

557 The root is omitted from inverted ninths.

558 The fourth inversion of the major ninth is not permitted.

574,5 A secondary ninth resolves by falling a second. The root rises a fourth. The ninth should be above the third (but see §614 and §416).

576 Where an inverted secondary ninth, not being a third inversion, has no root, the seventh is not dissonant and therefore does not require resolution.

582 The dominant eleventh resolves by: rising or falling a second, the rest of the chord remaining (dominant ninth) (or the ninth may also resolve); or remaining, the chord of resolution being a tonic common chord or a supertonic discord.

584 The seventh and ninth are subject to the rules of the dominant seventh and ninth except that where an inverted dominant eleventh has no root, the seventh and ninth are not dissonant and therefore do not require resolution.

587,590 The dominant thirteenth is rarely complete in practice. Either or both the ninth and thirteenth may be minor. Notes up to the eleventh are treated as in the dominant eleventh.

588 The dominant thirteenth may resolve by step while the rest of the chord remains, or the chord may resolve to a tonic chord, the thirteenth remaining, rising a semitone, or leaping to the tonic.

589 (Note 2) Rising a semitone only in major keys, the minor thirteenth rising to the tonic major third.

591 If the major thirteenth chord resolves on to a tonic chord, the thirteenth must leap to the tonic.

(c) The thirteenth must be sounded above the seventh, except when the thirteenth is in the bass.

596 In the major common chord of the supertonic, the third must not be doubled, and it rises or falls a semitone to the following chord. The chord of resolution must be some form of tonic common chord, or a chord containing a diatonic fourth, otherwise modulation occurs.

Interpretation: The best Implementation allows modulation to a dominant chord.

602 The supertonic seventh (that is, a fundamental discord) must fall a second or remain. In the latter case it may be doubled, and one of the two may leap. §596 applies to the third.

603 In the second inversion the root may be omitted and the seventh doubled (as §641).

605 The tonic seventh (that is, a fundamental discord) must be followed by a dominant or supertonic discord, or a subdominant chord.

606 The tonic seventh third may rise a second or fall a semitone.

607 The tonic seventh must fall a second or remain. It may not be doubled (cf §602).

608 The tonic seventh may be used in each inversion.

611,2 The supertonic ninth (that is, the fundamental discord) resolves by rising or falling a second, the chord following the rules for the dominant ninth. Alternatively, it may resolve on to a dominant discord, falling a second, remaining, or, if minor (ninth), rising a semitone.

614 The omission of the root and the positions of the third and major ninth are as for the dominant ninth—see §552, 4, 7.

633 The augmented sixth on the minor sixth resolves on:

(a) the tonic common chord or inversions,

(b) the dominant common chord or inversions,

(c) an inverted dominant ninth, or

(d) a supertonic discord.

634 The notes forming the augmented sixth interval should not proceed in similar motion. The other notes proceed as for supertonic discords: the third as for the seventh and the fifth as for the ninth.

Interpretation: The motion requirement is not mandatory, but the best Implementation requires it.

636 The augmented sixth may be used in the second inversion.

638 The augmented sixth on the minor second resolves in the equivalent manner of §633, except that in minor keys the tonic common chord is not permitted.

640 The diminished triad on the leading note must double only the third. The other notes are resolved as in their parent dominant seventh.

641 In the first inversion of that triad, the subdominant may be doubled, the upper falling and the lower rising.

642 The augmented fifth of the mediant in minor keys must be prepared, and is resolved by rising a second. The root rises a fourth to a common chord.

644, 5 The augmented fifth may be used in the relative major, that is, on the tonic, in which case the fifth is best approached by a semitone step. The best Implementation requires it.

646 The augmented fifth may be used on other notes of the scale.

647 The augmented fifthmay be used in the second inversion, as well as root and first inversions.

661-5 Modulation by enharmonic change is described, the point here being that a chord may be approached in one key and left (resolved as necessary) in another, the Rules being applied in each context.

References for the Rules:

1. Longmans' Music course Part II—Harmony and Counterpoint, T H Bertenshaw, Longmans Green and Co., London, 1926

2. Harmony Step by Step, Dulcie Holland, EMI Music Publishing, ISBN 0 86947 1449

3. The New Harmony Book, Frank Haunschild, AMA Verlag GmbH, Brühl, 1994, ISBN 3-927190-68-3

1. A Harmony Tester comprising means for
analyzing chords of notes according to the pitch of said notes to determine the semiton s separating said notes;
determining intervals separating said notes according to said semitones and according to accidental preference and current key and scale mode;
identifying chord degrees, species, modes and inversions by comparing said intervals and semitones with a plurality of chord structures;
determining intervals and semitones of progression of voices from chord to successive chord and determining intervals and semitones of progression of passing notes and their allies; and
testing said chords and progressions for compliance with a plurality of classical rules of harmony.

2. The Harmony Tester of claim 1 further comprising Automated Music Harmonizer means for automated creation of accompanying harmony for a Melody in accordance with rules of harmony by iterative successive chord selection by advance and retreat bytrial and error.

3. The Automated Music Harmonizer of claim 2 comprising:
means for the storage of a set of preferentially ordered chord specifications for each note appropriate to each scale mode for which the Harmonizer is intended to harmonize;
means for selecting in order from said set a chord specification for a Melody note according to its accidental, to its degree in the current scale and to the mode of the current scale;
means for creating in accordance with said chord specification a chord of parts to accompany said Melody note;
means for adding and subtracting, as required to fill accompanying voices, preferential doubling and omission of parts in accordance with harmony rules applicable to said chord;
means for testing for compliance with user Controls, user Preferences (as compromised) and a plurality of classical rules of harmony music thus far developed;
for the case of failure of said testing, means for re-assigning said parts, doubles and omissions, and for iterating the testing, until all part permutations are tried;
for the case of all part permutations failing, nested Preference iteration means for severally compromising Preferences in a plurality of steps from strong to weak, and for iterating the processing of the part permutations for each Preference compromise until all Preference compromises are tried;
means for controlling some of said Preference iterations, such that a Preference may be compromised not further than its corresponding Preference at the preceding Melody note, nor further than its next inner controlled Preference at the same Melody note;
means whereby in the absence of a preceding Melody note and an inner controlled Preference, the controlled Preference may be compromised;
for the case of all Preference compromises failing, means for selecting the next of said chord specifications, and for iterating the chord processing so far described, until all available chord specifications are tried;
for the case of all available chord specifications failing, means for retreating to the preceding Melody note and for continuing said selection of chord specifications and said chord processing iterations at said preceding Melody note as if the previous chord tested there had failed, or, in the case for which there was no such previous Melody note, means for ending the harmonizing process; and
for the case of success of said testing, means for advancing to the next Melody note for which a chord is required and for restarting said selection of chord specifications and said chord processing iterations, or, in the case for which there is no such next Melody note, means for ending the harmonizing process.

4. The Automated Music Harmonizer of claim 3 wherein the order of the iterations of the several controlled Preferences and the selection of chord specifications is altered.

5. The Automated Music Harmonizer of claim 3 further comprising means for detecting several said retreats without said advances whereupon said compromise of a controlled Preference disregards said corresponding Preference at the preceding Melody note.

6. The Automated Music Harmonizer of claim 3 further comprising:
means for associating hierarchical thresholds with said iterations of controlled Preferences;
means for relaxing levels of said thresholds in a plurality of steps from strong to weak upon completion of their associated iterations;
means for compromising said controlled Preferences from their strong level not beyond the levels of their associated thresholds, at successive completed iterations;
means for limiting the levels of each said threshold, such that a threshold may be relaxed not further than its next inner threshold of the iterations at the current Melody note; and
means whereby in the absence of an inner threshold, the threshold may be relaxed.

7. The Automated Music Harmonizer of claim 3 further comprising:
means for detecting modulation implied by the pitch, accent and accidentals of recent Melody notes, allowing that none, one or several modulations may be implied; and
means for rejecting a chord if its degree is not of said detected modulation(s).

8. The Automated Music Harmonizer of claim 3 further comprising:
means for scanning the Melody to establish the positions of beats and accents; and
means for rejecting a chord if it does not comply with Rules for beats and accents.

9. The Automated Music Harmonizer of claim 3 further comprising:
means for the storage of cadence progressions;
means for scanning the Melody to establish the positions of cadences; and
means for rejecting a chord if it does not comply with said cadence progressions.

10. The Automated Music Harmonizer of claim 3 further comprising means for the user to alter the chord frequency in terms of positions relative to rhythm;
the variation of tied cadences such that tied repeated Melody notes at a cadence are treated as the separate notes of a cadence;
the number of voices to be created;
the maximum ranges of created voices;
the tenor-to-bass maximum interval to beyond one octave;
the voice chosen as the Melody voice;
the requirement for creating a descant voice;
the descant voice as “vocal” or “instrument”, the instrument voice having greater freedom of interval from the Melody and greater range than does the vocal voice; or
the copying of ties or staccatos from the Melody to other voices;
such that the Harmonizer does not breach any such control so altered.

11. The Automated Music Harmonizer of claim 3 further comprising means for the user to alter:
a preferred degree of leaping permitted;
a preference to vary harmony at Melody note pitch repetition;
a preference to comply with modulation detected at cadences;
a preferred degree of close harmony;
a preference to avoid unison of selected adjacent voices; or
a preferred variation of the bass voice pitch at bars (measures);
such that the Harmonizer may compromise any such preference so altered.

12. The Automated Music Harmonizer of claim 3 further comprising:
means for saving user settings used in creating harmony; and
means for the user to retrieve said settings for use as settings for subsequent harmonizing.

13. The Automated Music Harmonizer of claim 3 further comprising:
means for the user to alter a Control “true descant” implying that music so harmonized with a descant part will sound harmonious with or without the descant performed; and
means whereby the Harmonizer assigns “true descant” parts such that the descant of each chord is not the only third of its chord, nor is a unique discord other than a seventh being the only discord.

14. The Automated Music Harmonizer of claim 3 further comprising:
means whereby the Harmonizer displays the characteristics of each created chord against Melody note such that its user may observe the progression of harmonizing processes; or
similarly, only those created chords complying with the Rules.

15. The Automated Music Harmonizer of claim 14 further comprising Tracing means whereby, as the user directs, the Harmonizer pauses such that the user may examine the harmonizing process.

16. The Automated Music Harmonizer of claim 3 further comprising integrated music Editor means:
for acquiring and editing the Melody for the Harmonizer;
for submitting the Melody to the Harmonizer;
for displaying and saving the harmony created by the Harmonizer;
for the user to revise the Melody, Preferences and/or Controls; and
for testing any music held by the Editor for compliance with the Rules of the Harmonizer.

17. The Automated Music Harmonizer of claim 16 wherein the editor further comprises means for automatically combining repeated notes into single notes of equivalent time.

18. A music editor means for editing music, comprising in addition to music editing means chord identification means whereby:
said editor analyzes chords of notes according to the pitch of said notes to determine the semitones separating said notes;
said editor determines the intervals separating said notes according to said semitones and according to accidental preference and current key and scale mode; and
said editor identifies chord degrees, species, modes and inversions by comparing said intervals and semitones with a plurality of chord structures.

19. The chord-identifying music editor of claim 18 further comprising means whereby said editor annotates music with said degrees, species, inversions, and modes.

20. The chord-identifying music editor of claim 18 further comprising means whereby said editor indicates to its user, for a user nominated chord, the degree, species, inversion, and mode so identified.

21. The chord-identifying music editor of claim 18 further comprising means whereby said editor annotates music with figured bass according to said intervals.

22. The chord-identifying music editor of claim 18 further comprising means whereby said editor seaches for chords having characteristics defined by its user.

23. The Harmony Tester of claim 1 further comprising means whereby said tester indicates failures of said testing to its user by identifiably colouring note symbols at or near said failures.

24. The Harmony Tester of claim 1 further comprising means whereby said tester indicates timing errors to its user by identifiably colouring the bar (measure) symbols near said errors.

25. The Harmony Tester of claim 1 further comprising means whereby said tester indicates failures of said testing to its user in text form.

26. The Harmony Tester of claim 25 further comprising means whereby, in cases of a plurality of failures, said tester indicates said texts to the user in time succession.

27. The Harmony Tester of claim 26 further comprising means whereby, as the user directs, said tester freezes and enables said time succession.
